(19) United States
(12) Patent Application Publication
(10) Pub. No.: US 2017/0255976 A1
(43) Pub. Date: Sep. 7, 2017

(54) METHOD FOR USER INITIATED SONG SELECTION OF AN ORDERED LIST ON A COMPUTER NETWORK

(71) Applicant: REX KUDO, Pacific Palisades, CA (US)

(72) Inventor: REX KUDO, Pacific Palisades, CA (US)

(21) Appl. No.: 15/057,296

(22) Filed: Mar. 1, 2016

(51) Int. Cl. G06Q 30/06; G06Q 20/12

(52) U.S. Cl. CPC G06Q 30/0607; G06Q 20/123

(57) ABSTRACT

A method for driving demand for downloading an ordered sequence of songs by requiring a minimum number of purchase/downloads for a currently available song of the ordered sequence of songs in order to make a next song of the sequence available to the buying public. Additionally, the rate and acceleration of purchases may be utilized to adjust the minimum number of required purchases.

### FIELD OF THE INVENTION

This invention relates to initiating additional song releases based on aggregate consumer utilization of an associated base repertory.

This invention relates to driving demand for one song to allow release of a second song, and sequentially through an ordered sequence of songs.

This invention relates to users on a computer network, e.g., the Internet.

### BACKGROUND OF THE INVENTION

Typically, released songs are obtained by a consumer by purchase and downloading utilizing the internet.

Sales are oriented toward a single consumer and that consumer's song interests.

Some song collections are arranged to suggest or provide related songs to a consumer.

Typically, song websites operate on a consumer's/user's interests and can provide songs based on consumer's explicit requests, or requests inferred from the context of user, i.e., related or associated songs. These collateral, related (by various specified criteria), song offerings are intended as a convenience for the consumer and a marketing tool for the song seller. See, for example, U. S. Pat. No. 9,262,534 (Feb. 16, 2016).

There are, however, other methods, not currently utilized, which might also tend to increase the consumption of additional songs.

This process of providing collateral song offerings is intended to help boost the sale of the additional songs.

### SUMMARY OF THE INVENTION

The invention uses the number of times a song is played to determine the release time of a next song, in a sequence of songs, which are released only when the specified preceding song has achieved a settable level of play.

As the songs become available, each newly released song must then be paid individually.

The source of the play request is not important; only the aggregate play requests is determinative.

The collection of play requests is facilitated by a computer network, e. g., the Internet.

Each song is assigned a unique digital or alphanumeric identifier by the song seller.

Each incoming song request is assigned to a bin according to its identifier. As the song is released to the consumer, the particular bin of that song records an increment in a counter.

When a song seller pre-set number of a first songs are downloaded to the consumers, the bin of the next song of the song sequence is opened and counting is established for that next song. After a second pre-set number of songs are downloaded, a third song bin is opened, and the process is continued.

For example, if the song seller sets the pre-set required song requests at 100,000 to release the next song of a sequence of songs, then if one consumer buys a song 100,000 times or 100,000 consumers initiates a single song buy, or some combination in between, the result in terms of releasing a song is same: the required pre-set number of sales of 100,000 has been reached and the next song is released.

It is anticipated that one consumer would communicate to many peers to purchase a song so as to reach a required number to release a next one, of an album, for example.

Variations of this basic process are also included. For example, the rate of sales may be used. Thus, for a pattern where sales increase level off, and decrease, the song seller may set a pre-determined profile, such that, for example, using the above 100,000 pre-set number, the song seller might find that there is an increasing rate of song sales for the first 25,000 songs sold, that for the next 15,000 songs the rate of sales has leveled off, and that the next 10,000 song sales shows a declining rate of sales. In that case, after a minimum song sales number, for example, 50,000, the next song would be released.

In this variation, in addition to a song bin counter, as above, a time stamp is associated with count number, such that a velocity of song sales is determined, as well as the acceleration or deceleration of sales.

The total number of sales and the velocity and acceleration of sales, when desired, is determined by algorithms. Thus, the profitability for the song list can be optimized based on song frequency requests.

A request for a buy and download of a song may be referred to as a song “hit.”

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates the method for deciding when to release a next song;

FIG. 1A diagrams the “domino” sequence of releasing songs;

FIG. 2 depicts an ordered song list;

FIG. 3 illustrates the method for deciding when to release a next song, with the ability to include song “hit” velocity and song “hit” acceleration as well as total number of song hits; and

FIG. 4 diagrams a method of including numbering and timing of song “hits”;

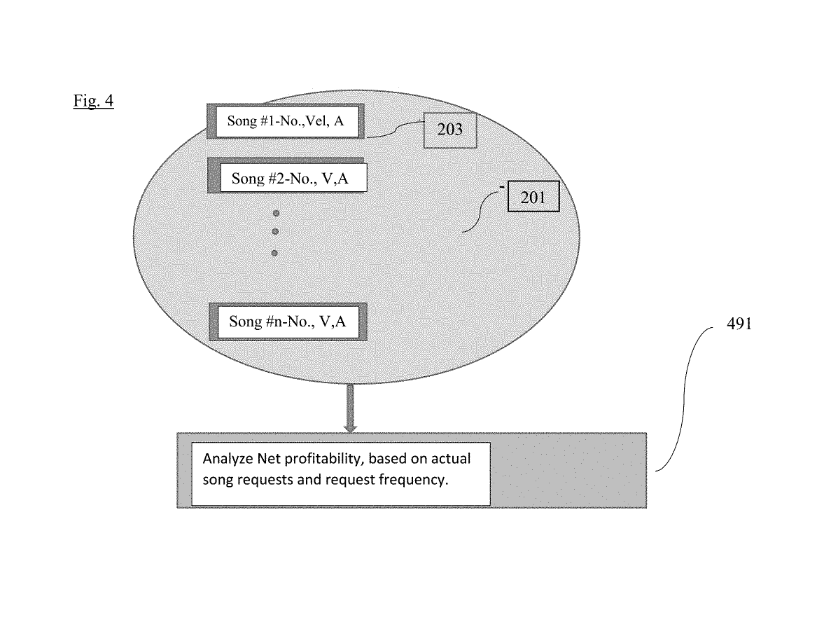

### DETAILED DESCRIPTION OF THE BEST MODE OF THE INVENTION

The following description is of the best mode presently contemplated for carrying out the invention. This description is not to be taken in a limiting sense, but is merely made for the purpose of describing the general principles of the invention.

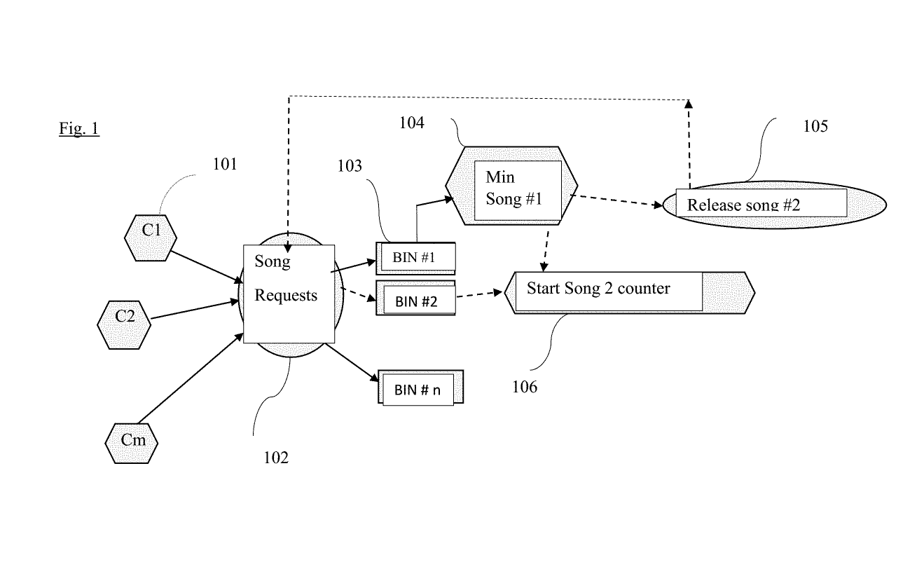

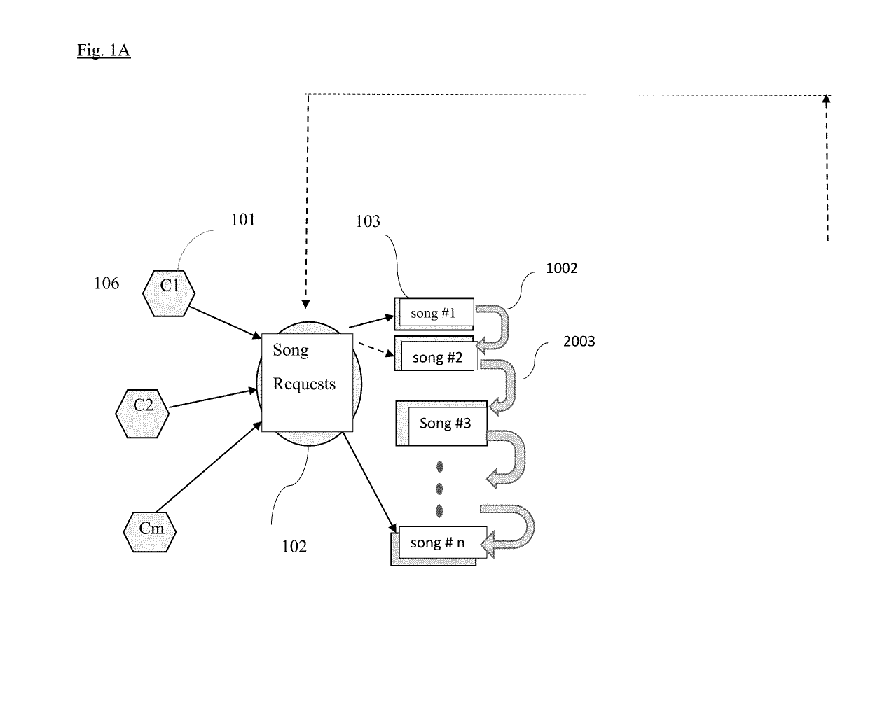

In a first preferred mode of the invention, FIG. 1 shows a number of consumers c1 101, c2, . . . , cm, where c1 101 is a first consumer, c2 a second consumer, up to an mth consumer cm. Each consumer buys 102 a first song 103. Access to a second song 105 occurs when the total number of song buys or hits equals to or is greater than a number 104 set by the song seller. The counter 106 for the number of “hits” for a second song of an ordered list is then initiated. The process continues such that when the minimum number of hits for song number 2 is reached or exceeded, a third song on the ordered list is released for access by the consuming public.

Thus, although theoretically one single consumer could engage the minimum number of hits to advance the next song release, the likely scenario is for peer to peer communication to drive that part of the potential consuming public to sooner reach the minimum number of hits to release the next song of the sequence.

This is a practical way to engage an interested part of the consuming public to increase rapidly the sale of an ordered list of songs. That ordered list might be a new song album release,

FIG. 1A diagrams the “domino” sequence of releasing songs. When the minimum required number of songs is reached for song 1, this triggers the release of song 2, 1002. When the minimum required number of songs is reached for song2, this then triggers the release of song3, 2003, and so on.

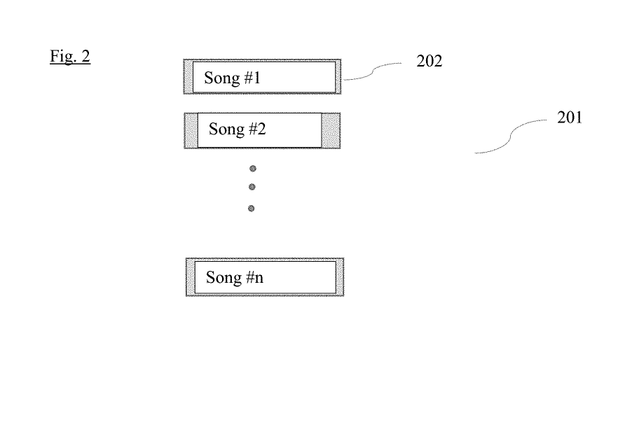

FIG. 2 depicts an ordered song list 21 with a first song 202.

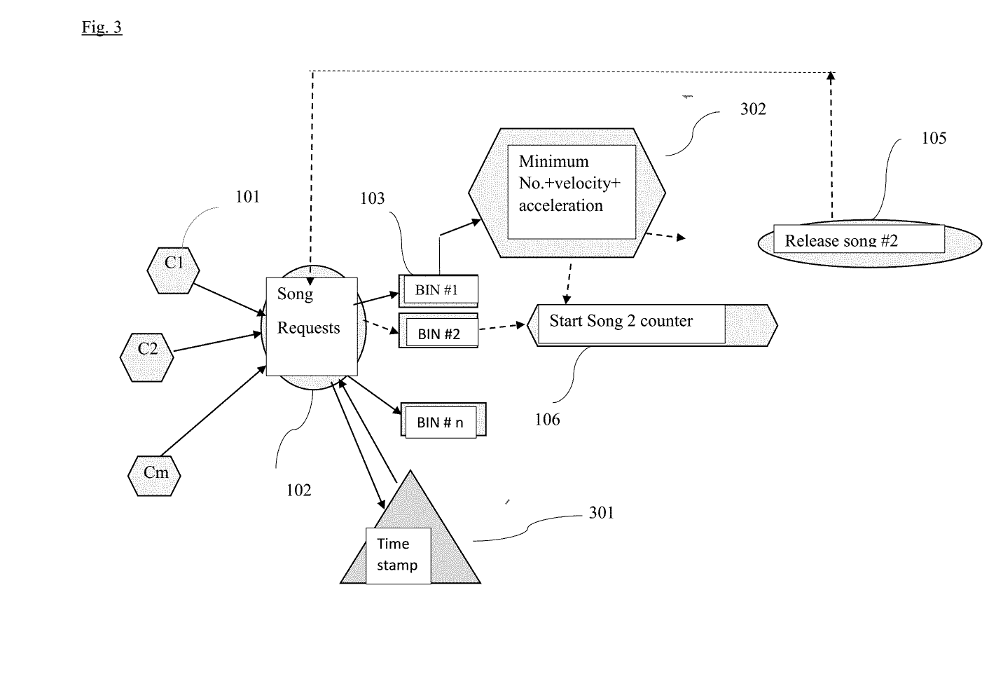

In a second preferred mode of the invention, FIG. 3 demonstrates the method of FIG. 1, but with the additional accumulation of a time stamp 301 which is associated with each song request 102. This information is retained allowing the computation 302 of the “velocity” 302 of ‘hits,’ i.e., hits per unit time and the “acceleration” 302 of “hits”, i.e., the rate of change of the “velocity” of “hits” or, the number of “hits” per unit time per unit time. This information 302 is available to the song seller so that adjustments may be made to the minimum number 302 of “hits” required to release the next song.

For example, if the velocity of “hits” is very high and the acceleration of “hits” is positive, the song seller might want to dynamically adjust he pre-selected minimum number of hits upward, that is, to increase the minimum number of hits 302 required to be met before releasing105 the next song, doing this on the ‘fly’

That way, where there is a high rate of demand and it is not slowing down, e.g., for a very popular song on a very popular song album, larger minimum numbers 302 would be required to advance through the album, or, ordered song list (FIG. 2, 201), yielding a larger net income to the song seller.

Conversely, when the songs or album are not in much demand, a lower minimum number (FIG. 3, 302) allows the song seller to run through ordered list (FIG. 2, 201) and move on to garnering hits for a new release, maximizing profits within a time-frame.

Each preferred mode of the invention is primarily based on driving demand by peer-to-peer communication, to release a next song (FIG. 1, 105 and FIG. 3, 105.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

It is claimed that:

1. A method to drive demand to download an ordered song list on a computer network, comprising:
offering for purchase and downloading an ordered sequence of songs with a plurality of songs on a computer network;
offering a first song which is purchasable and downloadable utilizing a computer network;
counting the total number of times a first song on the ordered sequence of songs has been purchased and downloaded a first song;
offering a second song of the ordered sequence of songs for purchase and downloading after a minimum number of the first song have been downloaded;
offering a next song on the ordered sequence of songs after a currently offered song has been purchased and downloaded a pre-set minimum number of times; and
offering all songs on the ordered sequence of songs for purchase and downloading after all songs have been sequentially purchased and downloaded, each, its pre-set minimum number of times.

2. The method of claim 1 wherein the computer network is the Internet.

3. A method to drive demand to download an ordered song list on a computer network, comprising:
offering for purchase and downloading an ordered sequence of songs with a plurality of songs on a computer network;
offering a first song which is purchasable and downloadable utilizing a computer network;
counting the total number of times, a first song on the ordered sequence of songs has been purchased and downloaded a first song;
assigning a time to each individual purchase/and download;
computing a running calculation of the number of purchases per unit time, and designating this number as a purchase velocity;
computing a running calculation of the number of purchases per unit time per unit time, and designating this number as a purchase acceleration;
offering a second song of the ordered sequence of songs for purchase and downloading after a minimum number of the first song have been downloaded;
adjusting the minimum number of times needed to advance to allowing the second song to download based on the purchase velocity and purchase acceleration of the first song;
offering a next song on the ordered sequence of songs after a currently offered song has been purchased and downloaded a minimum number of times; adjusting the minimum number of times needed to advance to allowing the next song to download based on the purchase velocity and purchase acceleration of the currently available song in the ordered sequence of songs; and
offering all songs on the ordered sequence of songs for purchase and downloading after all songs have been sequentially purchased and downloaded, each, its minimum number of times.

4. The method of claim 1 wherein the computer network is the Internet.

5. The method of claim 1 wherein the calculated purchase velocities and purchase accelerations are stored along with time stamps and numbers of songs sold.

6. The method of claim 1 wherein the adjustment to the minimum number of purchase and downloads of a currently available song in order to make a next song of the ordered song sequence available is based on an intuitive algorithm of the song seller.

7. The method of claim 1 wherein the adjustment to the minimum number of purchase and downloads of a currently available song in order to make a next song of the ordered song sequence available is based on an algorithm of the song seller wherein the algorithm is derived from a knowledge base accumulated by the song seller over time.
